(19) United States
(12) Patent Application Publication
(10) Pub. No.: US 2004/0204169 A1
(43) Pub. Date: Oct. 14, 2004

(54) Carrying device having an interchangeable face plate

(75) Inventor: Harold A. Goradesky, Miami, FL (US)

Correspondence Address: ROBERT C. KAIN, JR., 750 SOUTHEAST THIRD AVENUE, SUITE 100, FT LAUDERDALE, FL, 333161153

(73) Assignee: A. G. Findings & Mfg. Co., Inc.

(21) Appl. No.: 10/412,820

(22) Filed: Apr. 11, 2003

(51) Int. Cl. H04M 1/00

(52) U.S. Cl. 455/569.1; 455/575.1

(57) ABSTRACT

A carrying device is provided for removably coupling a portable device to a user's person. The carrying device includes a main body coupled to the portable device, a clip arm coupled to the main body, and an interchangeable face plate that is removably coupled to the main body. The clip arm and main body are coupled together so as to allow the portable device to be removably coupled to the user's person. In one embodiment, the interchangeable face plate includes means for aligning and/or securing the interchangeable face plate to the main body, such as locking tabs, aligning posts, lateral aligning posts, and/or snap lock tabs.

### BACKGROUND OF THE INVENTION

This invention relates to the field of carrying devices, and more particularly to a carrying device having an interchangeable face plate.

Portable electronic devices are continually increasing in popularity. Portable electronic devices include, for example, wireless (cell) phones, personal digital assistants (PDAs), MP3 music players, two-way radios, global positioning systems (GPS) and other satellite communication systems, and hand-held computers and internet browsers. The growing assortment of personal electronic devices on the market is continually decreasing in physical size and weight, so these devices lend themselves to being carried on a user's person (for example, a user's waist belt, purse, or pocket).

FIGS. 1A and 1B illustrate a typical conventional carrying device. This carrying device for portable electronic devices includes a one-piece main body (100) and a clip arm (102) attached together by a leaf spring (104). The clip arm enables the carrying device to be attached to a user's person, such as a waist belt, purse, and so on. The main body is designed to mate with a mounting post that is typically coupled (either removably or permanently) to a portable electronic device. Generally, the main body and mounting post are designed to mate in a secure yet removable fashion, so as to enable the portable electronic device to be quickly, easily, and securely mounted, carried, and removed from the carrying device. In some carrying devices, removal of a portable electronic device from the carrying device is achieved by pressing a release button located on the main body of the carrying device.

The carrying device is visible when worn on the user's person (waist belt, purse, and so on), and therefore is part of the user's dress and fashion. Consequently, there is a growing demand for carrying devices that are aesthetically attractive as well as customizable by the user. Additionally, companies that sell carrying devices often desire to have their company logo appear on the carrying device.

However, the one-piece design of the main body of current carrying devices does not allow these carrying devices to be customized by the user. Moreover, the one-piece main body design of current carrying devices (which is typically molded of plastic using standard injection molding techniques) requires significant modifications during the manufacturing process in order to produce different variations of a carrying device. This increases costs and prolongs production times. Additionally, current carrying devices suffer from the lack of a proper grip surface on the main body which causes the carrying device to easily slip out of the user's fingers when opening the clip arm during mounting.

### SUMMARY OF THE INVENTION

In view of these drawbacks, it is an object of the present invention to overcome the above-mentioned drawbacks and to provide a carrying device that can be easily customized by a user, manufacturer, vendor, customer, and/or other party.

Another object of the present invention is to provide a carrying device with an improved ergonomic grip surface.

One embodiment of the present invention provides a carrying device for removably coupling a portable device to a user's person. The carrying device includes a main body coupled to the portable device, a clip arm coupled to the main body, and an interchangeable face plate that is removably coupled to the main body. The clip arm and main body are coupled together so as to allow the portable device to be removably coupled to the user's person. In a preferred embodiment, the interchangeable face plate includes means for aligning and/or securing the interchangeable face plate to the main body, such as locking tabs, aligning posts, lateral aligning posts, and/or snap lock tabs.

Another embodiment of the present invention provides an interchangeable face plate for a carrying device of the type that removably couples a portable device to a user's person. The interchangeable face plate includes a front-side, and a back-side opposite the front-side. The back-side is capable of engaging the carrying device such that the interchangeable face plate can be removably coupled with the carrying device. In one embodiment, the front-side includes visible advertising indicia such as a logo, a company name, and/or a trademark.

Other objects, features, and advantages of the present invention will become apparent from the following detailed description. It should be understood, however, that the detailed description and specific examples, while indicating preferred embodiments of the present invention, are given by way of illustration only and various modifications may naturally be performed without deviating from the present invention.

### BRIEF DESCRIPTION OF THE DRAWINGS

Further objects and advantages of the present invention can be found in the detailed description of the preferred embodiments when taken in conjunction with the accompanying drawings in which:

FIG. 1A is a diagram showing a three-dimensional view of a conventional carrying device.

FIG. 1B is a diagram showing a side view of the conventional carrying device shown in FIG. 1A.

FIG. 2 is a three-dimensional view of a carrying device with an interchangeable face plate coupled to the main body, in accordance with a preferred embodiment of the present invention.

FIG. 3 is a three-dimensional view of the carrying device shown in FIG. 2 with the interchangeable face plate removed from the main body.

FIG. 4 is another three-dimensional view of the carrying device with the interchangeable face plate removed from the main body.

FIG. 5 is a side view of the carrying device of FIG. 2 with the interchangeable face plate coupled to the main body.

FIG. 6 is a three-dimensional view of an interchangeable face plate according to a preferred embodiment of the present invention.

FIG. 7A is a diagram showing a three-dimensional, exploded view of the front-side of a carrying device having an interchangeable face plate according to one embodiment of the present invention.

FIG. 7B is a diagram showing a three-dimensional, exploded view of the back-side of the carrying device shown in FIG. 7A.

FIGS. 8A to 8E show detailed manufacturing diagrams of an interchangeable face plate according to one embodiment of the present invention.

FIGS. 9A to 9F show detailed manufacturing diagrams, from the perspective of FIG. 9G, of a carrying device having an interchangeable face plate according to one embodiment of the present invention.

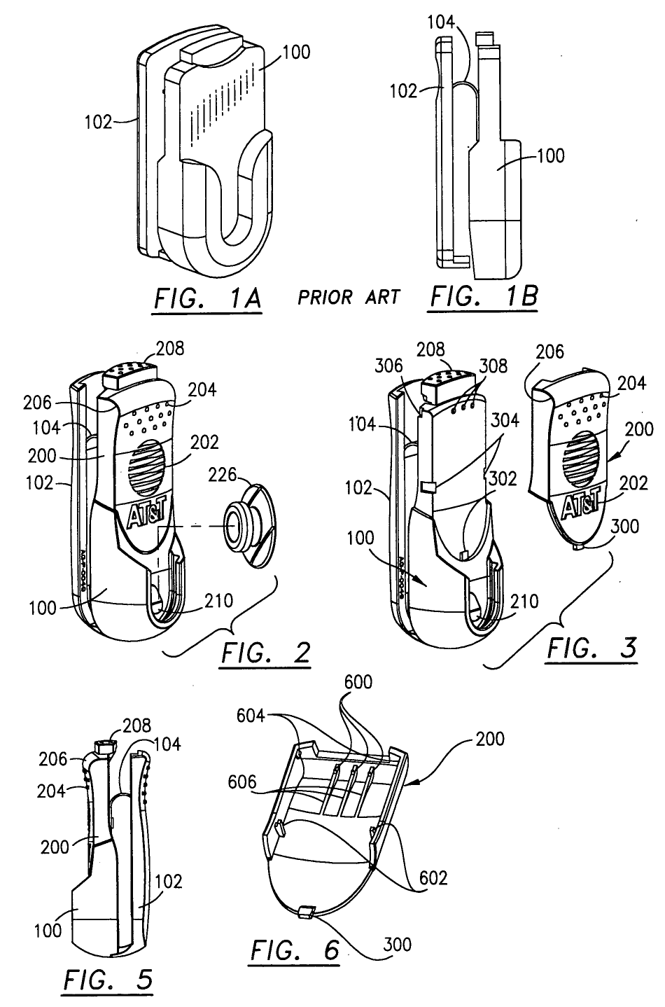

### DETAILED DESCRIPTION OF THE PREFERRED EMBODIMENTS

The present invention, according to a preferred embodiment, overcomes problems with the prior art by providing a carrying device, such as a belt clip for carrying a portable electronic device on a user's person, having an interchangeable face plate. The interchangeable face plate allows a user to easily personalize the carrying device to their liking, such as by altering the visual appearance or the ergonomic grip surface. Furthermore, the interchangeable face plate improves manufacturing efficiency in that a limitless variety of designs, logos, colors, styles, contours, surface features, ergonomic grip surfaces, and the like, can be readily introduced to the same basic carrying device by way of the interchangeable face plate. In preferred embodiments of the present invention, the interchangeable face plate has an ergonomic grip surface, which significantly improves a user's ability to open a clip arm during mounting and removal.

For convenience, the following description and figures are directed to a preferred embodiment, in which the carrying device is embodied as a clip-type carrying device having a clip arm for attaching to a user's person (waist belt, pocket, purse, and so on). However, the present invention is not limited to such carrying devices. For example, further embodiments provide carrying devices that attach by way of buttons, straps, Velcro, or any other suitable fastener.

FIGS. 2-5, 7, and 9 illustrate various views of an exemplary carrying device having an interchangeable face plate according to a preferred embodiment of the present invention. FIGS. 6 and 8 illustrate various views of an exemplary interchangeable face plate according to a preferred embodiment of the present invention.

FIG. 2 shows an exemplary carrying device that includes a main body 220 and clip arm 222 coupled together by a leaf spring 224. FIG. 2 also illustrates an exemplary mounting post 226, which would typically be coupled to a portable electronic device such as a cell phone (not shown in FIG. 2), either in a removable or permanent fashion. The mounting post 226 is preferably designed to mate in a secure yet removable fashion with the main body 220 of the carrying device, so as to enable a portable electronic device to be quickly, easily, and securely mounted, carried, and removed from the carrying device. The exemplary carrying device shown in FIG. 2 also has a release button 208 which, when pressed, acts to withdrawal a release tab 210. In situations in which a mounting post 226 (and, typically, a corresponding portable electronic device) is mounted to the carrying device, withdrawal of the release tab 210 by pressing the release button 208 would release pressure that is normally applied by the release tab 210 against the mounting post 226 to hold the mounting post 226 in place against the main body 220 of the carrying device. This enables the mounting post 226 (and, consequently, a corresponding portable electronic device) to be removed from the carrying device.

FIG. 2 also illustrates an interchangeable face plate 200. In FIG. 2, the interchangeable face plate 200 is shown coupled to the main body 220. Although FIGS. 2 through 9 show the interchangeable face plate 200 with an exemplary logo 202, raised grip features 204, and a contoured surface 206, these are merely exemplary representations. The interchangeable face plate 200 is capable of being customized in an endless variety of ways. For example, the interchangeable face plate 200 can have any desired logo (e.g., the logo of any organization, company, or sports team), design, or color scheme, as well as any desired physical surface features such as different contours and raised or recessed surface features. Furthermore, the interchangeable face plate 200 can have a different appearance (e.g., a different color scheme) from the main body 220, if desired.

FIG. 3 illustrates the exemplary carrying device from the same viewing angle as shown in FIG. 2. However, in FIG. 3, the interchangeable face plate 200 is shown removed from the main body 220. FIG. 3 also illustrates a locking tab 300 on the interchangeable face plate 200. In the exemplary configuration shown in FIG. 3, the locking tab 300 is designed to fit into a locking tab notch 302 on the main body 220. Also shown in the exemplary configuration illustrated in FIG. 3 are lateral aligning post notches 304 on the main body 220, which are designed to engage lateral aligning posts 602 (FIG. 6) present on the interchangeable face plate 200. Additionally, FIG. 3 illustrates snap lock notches 306, which are designed to engage snap lock tabs 604 (FIG. 6) present on the interchangeable face plate 200. FIG. 3 also shows aligning post notches 308, which are designed to engage aligning posts 600 (FIG. 6). These respective engagements of the locking tab 300 with the locking tab notch 302, the lateral aligning post notches 304 with the lateral aligning posts 602, the snap lock notches 306 with the snap lock tabs 604, and the aligning post notches 308 with the aligning posts 600, assist in aligning and securing the interchangeable face plate 200 to the main body 220. Preferred embodiments of the present invention include one or more of these engagements for aligning and securing the interchangeable face plate. Further embodiments include any other suitable engagement that can align and/or secure the interchangeable face plate.

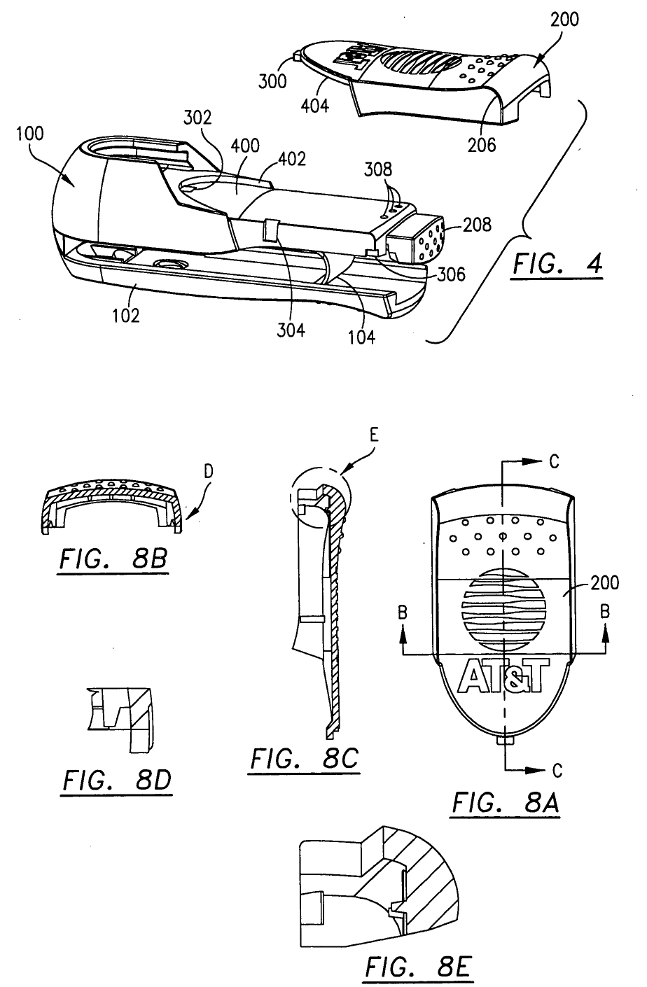

FIG. 4 is another illustration of the exemplary carrying device shown in FIGS. 2 and 3, but from a different viewing angle. FIG. 4 illustrates a relief area 400 on the main body 220, in which the interchangeable face plate 200 can be inserted in accordance with preferred embodiments of the present invention. In preferred embodiments, the depth 402 of the relief area 400 approximately matches the width 404 of the interchangeable face plate 200 so that the interchangeable face plate 200 does not substantially protrude outward when coupled to the main body 220. This design can give the appearance that the interchangeable face plate 200 and the main body 220 together form one-piece when these two components are coupled together. However, in further embodiments, the depth 402 of the relief area 400 and width 404 of the interchangeable face plate 200 can differ. Furthermore, the main body 100 can be designed without any relief area 400; any configuration of the main body 100 that accepts the interchangeable face plate 200 can be utilized.

FIG. 5 is another illustration of the exemplary carrying device shown in FIGS. 2, 3, and 4, but from a side view. FIG. 5 clearly shows the interchangeable face plate 200 having a contoured surface 206, in accordance with preferred embodiments of the present invention. The contoured surface 206, as well as raised grip features 204 and other surface features, of the interchangeable face plate 200 provides an ergonomic grip surface that helps prevent the carrying device from slipping out of a user's fingers when the interchangeable face plate 200 and clip arm 222 are pressed together in order to open the clip arm 222, such as during mounting and removal. Additionally, to further enhance the ergonomic grip surface of the carrying device, the exemplary clip arm 222 shown in FIG. 5 also has a contoured surface and raised grip features, which are analogous to those present on the interchangeable face plate 200.

FIG. 6 illustrates an interchangeable face plate 200 according to a preferred embodiment of the present invention. In FIG. 6, the side of the interchangeable face plate 200 that engages the main body 220 of a carrying device is shown. As illustrated in FIG. 6, the interchangeable face plate 200 of preferred embodiments can include any or all of the following: aligning posts 600, lateral aligning posts 602, snap lock tabs 604, ribs 606, and locking tab 300. FIG. 6 illustrates an interchangeable face plate 200 having three aligning posts 600 and three ribs 606, a pair of lateral aligning posts 602, a pair of snap lock tabs 604, and one locking tab 300 in an exemplary configuration. However, as throughout the present disclosure, this is merely an illustration of an exemplary embodiment, and any number of each or any of these features can be present, and in any desired configuration. Further embodiments include any other suitable engagement.

As described above with reference to FIG. 3, the aligning posts 600 are designed to engage the aligning post notches 308 on the main body 220, the lateral aligning posts 602 are designed to engage the lateral aligning post notches 304 on the main body 220, the snap lock tabs 604 are designed to engage the snap lock notches 306 on the main body 220, and the locking tab 300 is designed to engage the locking tab notch 302 on the main body 220. These respective engagements of the aligning posts 600 with the aligning post notches 308, the lateral aligning posts 602 with the lateral aligning post notches 304, the snap lock tabs 604 with the snap lock notches 306, and the locking tab 300 with the locking tab notch 302, assist in aligning and securing the interchangeable face plate 200 to the main body 220.

In the exemplary configuration illustrated in FIG. 6, the aligning posts 600 and ribs 606 not only assist in aligning and securing the interchangeable face plate 200 to the main body 100, but also serve to support the interchangeable face plate 200 during depression of a user's finger on the interchangeable face plate 200, such as when the interchangeable face plate 200 and clip arm 222 are pressed together in order to open the clip arm 222.

In alternative embodiments, other configurations are utilized for aligning and securing the interchangeable face plate 200 to the main body 220. For example, the interchangeable face plate 200 and/or main body 220 can incorporate any desired configuration of clips, pins, posts, tabs, notches, grooves, lips, tongues, and so on, to facilitate the alignment, securing, and/or release of the interchangeable face plate 200 to and from the main body 220. A slide-on tongue and groove-lip configuration can be incorporated, for example, such as along the sides of the interchangeable face plate 200. The securing and removal of the interchangeable face plate 200 to and from the main body 220 can be achieved by any desired mechanism, such as mechanisms having a snap-on/snap-off action (which may also be referred to as a clip-on/clip-off action), a slide-on/slide-off action, and so on. Preferably, a strong and self-aligning fit of the interchangeable face plate 200 to the main body 220 is achieved. It is also preferable that the interchangeable face plate 200 can be secured to, and removed from, the main body 220 without the need to use tools.

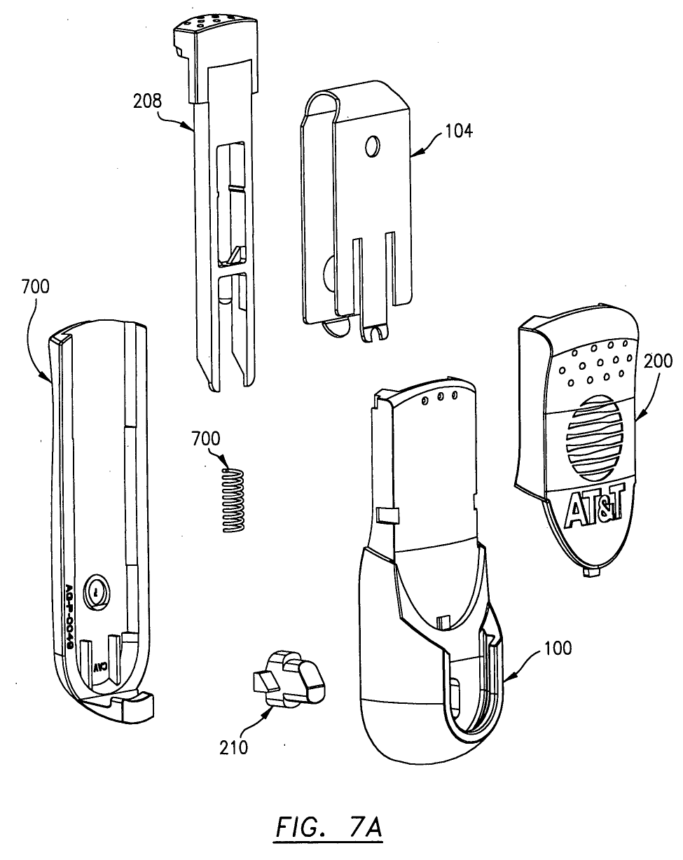

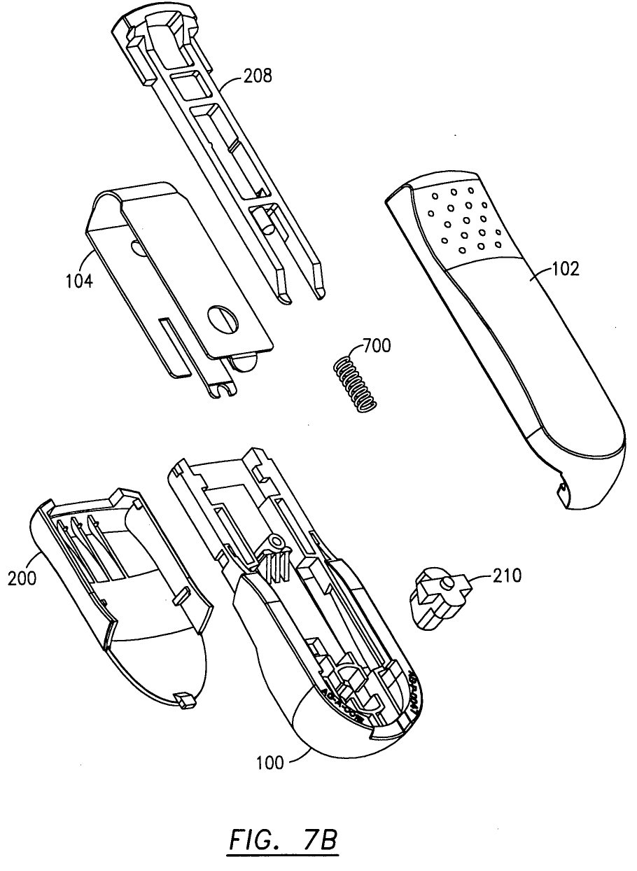

FIGS. 7A and 7B show an exploded view of the exemplary carrying device and interchangeable face plate 200 shown in FIGS. 2 through 6. FIGS. 7A and 7B illustrate the relationship between the individual component parts of the exemplary carrying device, including the main body 220, clip arm 222, leaf spring 224, interchangeable face plate 200, release button 208, release tab 210, and a release spring 700. The release spring 700 interacts with the release button 208 and the release tab 210 to facilitate movement of these parts. FIGS. 7A and 7B also indicate how the exemplary carrying device can be assembled from individual components by means of conventional manufacturing techniques.

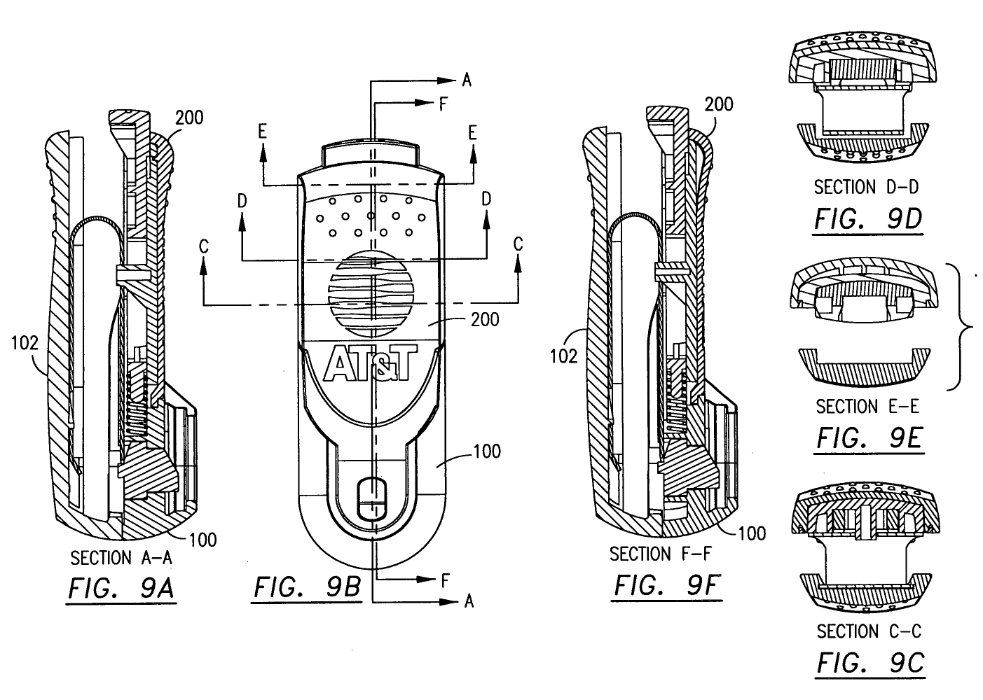

FIGS. 8 and 9 are detailed manufacturing diagrams that can be used to manufacture a carrying device having an interchangeable face plate using of conventional manufacturing techniques. FIG. 8 illustrates an exemplary interchangeable face plate 200, including front, side, and detailed views. FIG. 9 illustrates an exemplary carrying device having an interchangeable face plate 200, including front, side, and cross-sectional views.

The interchangeable face plate 200 according to preferred embodiments of the present invention enhances manufacturing efficiency in that a limitless variety of designs (e.g., logos, colors, styles, contours, surface features, and ergonomic grip surfaces) can be readily imparted to the same basic carrying device by way of the interchangeable face plate 200. This leads to reduced manufacturing costs and shortened production times, while increasing the diversity of potential designs that can be feasibly manufactured. For example, because the interchangeable face plate 200 can be molded (e.g., molded of plastic using conventional injection molding techniques) in a separate mold from the main body 220, the interchangeable face plate 200 can be readily molded in a limitless variety of designs while avoiding the significant expense and prolonged production lead times that would be necessary to modify the mold for the main body in order to impart each different design to conventional carrying devices.

The adaptability that the interchangeable face plate 200 imparts to a carrying device enables a wide variety of uses that are not possible with conventional carrying devices. Furthermore, anyone involved with carrying devices, such as users, manufacturers, vendors, and customers, can benefit from the adaptability provided by the interchangeable face plate 200.

For example, the interchangeable face plate can be imparted with advertising indicia, such as a trademark, a company logo, a company name, or contact information. In this manner, the interchangeable face plate itself (or a carrying device including an interchangeable face plate) could be a marketing give away to promote goods or services, for example. Furthermore, because the interchangeable face plate rather than the main body can carry advertising indicia, the same basic manufacture of the main body can be utilized for multiple customers. Only the manufacture of the interchangeable face plate needs to be modified to have the advertising indicia desired by each different customer.

Additionally, the low cost involved in manufacturing different variations of the interchangeable face plate allows a carrying device to be packaged and sold with interchangeable face plates having numerous different designs (e.g., different color schemes). This allows a user to tailor the appearance of the carrying device according to their particular fashion style or attire.

Furthermore, the interchangeable face plate can have the designs or logos of any organization, including, for example, the colors and logos of sports teams. The ability to readily impart such organizational designs/logos can be valuable for increasing sales of a carrying device. It enables the carrying device to have a distinctive appearance compared with others on the market so as to capture the attention of customers. Moreover, the ability to show support for a sports team or other organization is appealing to many customers, thus providing a competitive advantage in various markets and consequently leading to increased sales.

Additionally, the ability to readily impart a different organizational design/logo to a carrying device by way of replacing the interchangeable face plate is also advantageous to customers, in that if a customer switches their association or support to a different organization, or supports multiple organizations, it is a simple matter to exchange the interchangeable face plate rather than having to obtain a new carrying device.

As yet another example, the appearance (e.g., color) of the interchangeable face plate can be coordinated to match the appearance of a portable electronic device (e.g., a cell phone). This aids in identification and prevents mix-up or theft.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

The claims appended hereto are meant to cover modifications and changes within the scope and spirit of the present invention.

What is claimed is:

1. A carrying device for removably coupling a portable device to a user's person, said carrying device comprising:
a main body coupled to the portable device;
a clip arm coupled to the main body; and
an interchangeable face plate removably coupled to the main body,
wherein the clip arm and main body are coupled together so as to allow the portable device to be removably coupled to the user's person.

2. The carrying device of claim 1, further comprising a leaf spring for coupling the clip arm to the main body.

3. The carrying device of claim 1, wherein the portable device is a portable electronic device.

4. The carrying device of claim 1, wherein the interchangeable face plate includes at least one visible advertising indicia selected from the group consisting of a logo, a company name, and a trademark.

5. The carrying device of claim 1, wherein the interchangeable face plate includes at least one physical surface feature selected from the group consisting of ergonomic grip surfaces, raised surface features, recessed surface features, and contours.

6. The carrying device of claim 1, wherein the interchangeable face plate is removably coupled to the main body by a mechanism having a snap-on/snap-off action and/or a slide-on/slide-off action.

7. The carrying device of claim 1, wherein the interchangeable face plate includes means for aligning and/or securing the interchangeable face plate to the main body.

8. The carrying device of claim 7, wherein the means for aligning and/or securing includes at least one of locking tabs, aligning posts, lateral aligning posts, and snap lock tabs.

9. The carrying device of claim 7, wherein the main body includes second means for aligning and/or securing the interchangeable face plate to the main body.

10. The carrying device of claim 9, wherein the second means for aligning and/or securing includes at least one of locking tab notches, lateral aligning post notches, snap lock notches, and aligning post notches.

11. The carrying device of claim 1, wherein the interchangeable face plate is removably coupled to the main body by way of a slide-on tongue and groove-lip mechanism.

12. The carrying device of claim 1, wherein the interchangeable face plate includes at least one rib for supporting the interchangeable face plate during depression of a user's finger on the interchangeable face plate.

13. The carrying device of claim 1, wherein the main body includes a relief area for accepting the interchangeable face plate.

14. An interchangeable face plate for a carrying device of the type that removably couples a portable device to a user's person, said interchangeable face plate comprising:
a front-side; and
a back-side opposite the front-side, the back-side being capable of engaging the carrying device such that the interchangeable face plate can be removably coupled with the carrying device.

15. The interchangeable face plate of claim 14, wherein the front-side includes at least one visible advertising indicia selected from the group consisting of a logo, a company name, and a trademark.

16. The interchangeable face plate of claim 14, wherein the front-side includes at least one physical surface feature selected from the group consisting of ergonomic grip surfaces, raised surface features, recessed surface features, and contours.

17. The interchangeable face plate of claim 14, wherein the back-side includes at least one mechanism for removably coupling the interchangeable face plate to a main body of the carrying device, the at least one mechanism having a snap-on/snap-off action and/or a slide-on/slide-off action.

18. The interchangeable face plate of claim 14, wherein the back-side includes means for aligning and/or securing the interchangeable face plate to a main body of the carrying device.

19. The interchangeable face plate of claim 18, wherein the means for aligning and/or securing includes at least one of locking tabs, aligning posts, lateral aligning posts, and snap lock tabs.

20. The interchangeable face plate of claim 14, wherein the back-side includes at least one rib for supporting the interchangeable face plate during depression of a user's finger on the interchangeable face plate.
